(19) United States
(12) Patent Application Publication
(10) Pub. No.: US 2004/0047359 A1
(43) Pub. Date: Mar. 11, 2004

(54) Adapting a computer bus to carry telephony data

(76) Inventors: William E. Jacobs, Satellite Beach, FL (US); Tim Scheffler, Melbourne, FL (US)

Correspondence Address: KENYON & KENYON, 1500 K STREET, N.W., SUITE 700, WASHINGTON, DC, 20005, US

(21) Appl. No.: 10/235,500

(22) Filed: Sep. 6, 2002

(51) Int. Cl. H04L 12/28

(52) U.S. Cl. 370/402

(57) ABSTRACT

A method of interfacing telephone data with a computer system that includes a computer TDM bus. The method includes receiving the telephone data from a plurality of telephony codecs over a telephony bus. The telephony data includes a plurality of telephony time slots. The method further includes multiplexing the plurality of telephony slots into at least one computer bus time slot and transmitting the at least one computer bus time slot over the computer time division multiplexed bus.

### FIELD OF THE INVENTION

One embodiment of the present invention is directed to telephony data. More particularly, one embodiment of the present invention is directed to carrying telephony data on a computer bus.

### BACKGROUND INFORMATION

Computers are frequently being used for telephony applications. For example, many computers are used as end-points or gateways in Voice over Internet Protocol (“VoIP”) implementations in which telephone calls are transmitted by the Internet, or a combination of the Internet and the Public Switched Telephone Network (“PSTN”). Computers are also frequently used as substitutes for traditional Private Branch Exchanges (“PBXs”).

One hurdle that must be overcome when a computer interfaces with the PSTN or other telephony carrying networks is that the data format on computer busses is frequently incompatible with the data format on telephony busses. Telephony data is typically carried on a Time Division Multiplexed (“TDM”) bus having a framing of 125 μs per frame. In contrast, computers typically carry internal data on incompatible busses such as a Universal Serial Bus (“USB”), a Peripheral Component Interconnect (“PCI”) bus, or an Ethernet bus.

### BRIEF DESCRIPTION OF THE DRAWINGS

FIG. 1 is a block diagram of an interface system in accordance with one embodiment that enables a telephony bus and telephony codecs to interface with an AC '97 computer bus.

FIG. 2 illustrates the telephony channel usage of the AC '97 bus protocol performed by a MUX module of FIG. 1.

FIGS. 3a and 3b illustrates a map of the AC '97 telephony registers in accordance with one embodiment of the present invention.

FIG. 4 illustrates a bring-up state machine in accordance with one embodiment of the present invention.

### DETAILED DESCRIPTION

One embodiment of the present invention is a method and apparatus for enabling telephony data to be carried on a TDM bus for a computer system. In one embodiment, the TDM bus is the Audio Codec '97 (“AC '97”) computer bus from Intel Corp. However, embodiments of the present invention may include any TDM bus for a computer system.

### Architecture

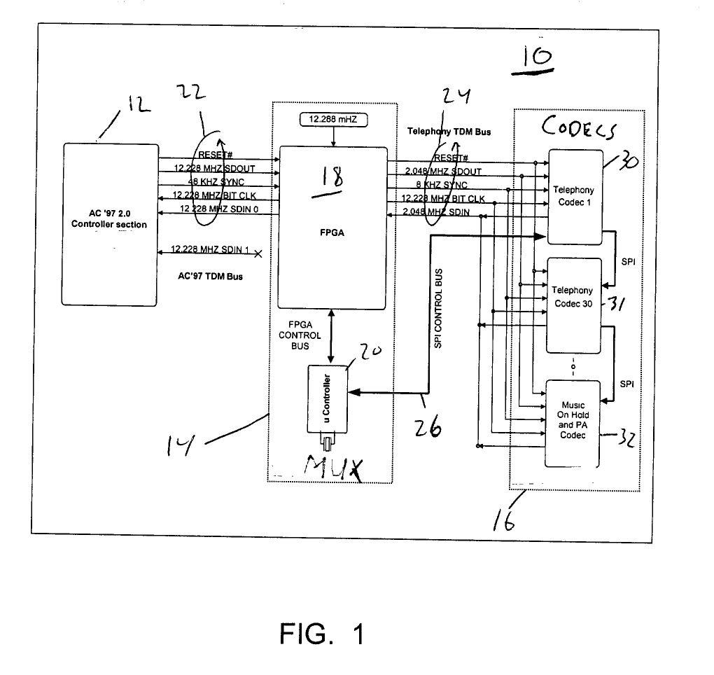

FIG. 1 is a block diagram of an interface system 10 in accordance with one embodiment that enables a telephony bus and telephony codecs to interface with an AC '97 computer bus. The AC '97 computer bus defines a high-quality, 20-bit audio architecture for a personal computer that in one embodiment includes a Pentium processor from Intel Corp. AC '97 is a 48 KHz TDM bus with a framing at 20.833333 μs per frame. The AC '97 Component Specification version 2.3 provides a detailed description of the AC '97 bus, and is herein incorporated by reference.

Interface system 10 includes a telephony codec module 16. Codec module 16 receives up to thirty channels of telephony data from telephone lines (not shown) into a telephony codec for each channel. In one embodiment, codecs 30 and 31 may be various types such as SLIC/MSI, DAA/LSI, Proprietary Digital PBX or T1/E1 codecs. Two of the 30 μlaw/alaw telephony codecs, codecs 30 and 31, are shown in FIG. 1. Telephony codecs use a TDM bus with a framing at 125 μs per frame. Module 16 further includes a 16 bit linear Music on Hold input codec and a 16 bit linear PA output codec 32. The codecs of module 16 may be any type of codec that supports the “standard” 125 μs telephony TDM bus and uses a Serial Peripheral Interface (“SPI”) bus for control/status. Module 16 may also support a 16 bit linear, 16 Khz Modem codec, a full T1 span, and a full E1 span with HDLC signaling.

Telephony codec module 16 is coupled to a MUX module 14 though a telephony TDM bus 24 and an SPI control bus 26. MUX module 14 includes a micro-controller 20 that provides and services the AC '97 codec registers. These registers fall into two categories. The first category is comprised of the registers that present the AC '97 primary codec profile. The second category are pass-thru registers for accessing the telephony codecs. Micro-controller 20 serves as the transport mechanism (via SPI bus 26) to access the registers in the telephony codecs.

MUX module 14 also includes a Field-Programmable Gate Array (“FPGA”) 18 or any other logic module. FPGA 18 performs mux/demuxing and the timing between two different TDM buses (i.e., telephony TDM bus 24 and an AC '97 TDM bus 22). FPGA 18 further funnels the AC '97 control/status timeslots (timeslots 1 and 2) to/from micro-controller 20.

Coupled to MUX module 14 via AC '97 TDM bus 22 is an AC '97 controller 12. AC '97 controller 12 is further disclosed in the AC '97 Component Specification version 2.3. In one embodiment, AC '97 controller 12 includes at least one direct memory access (“DMA”) engine to transmit telephony data to memory.

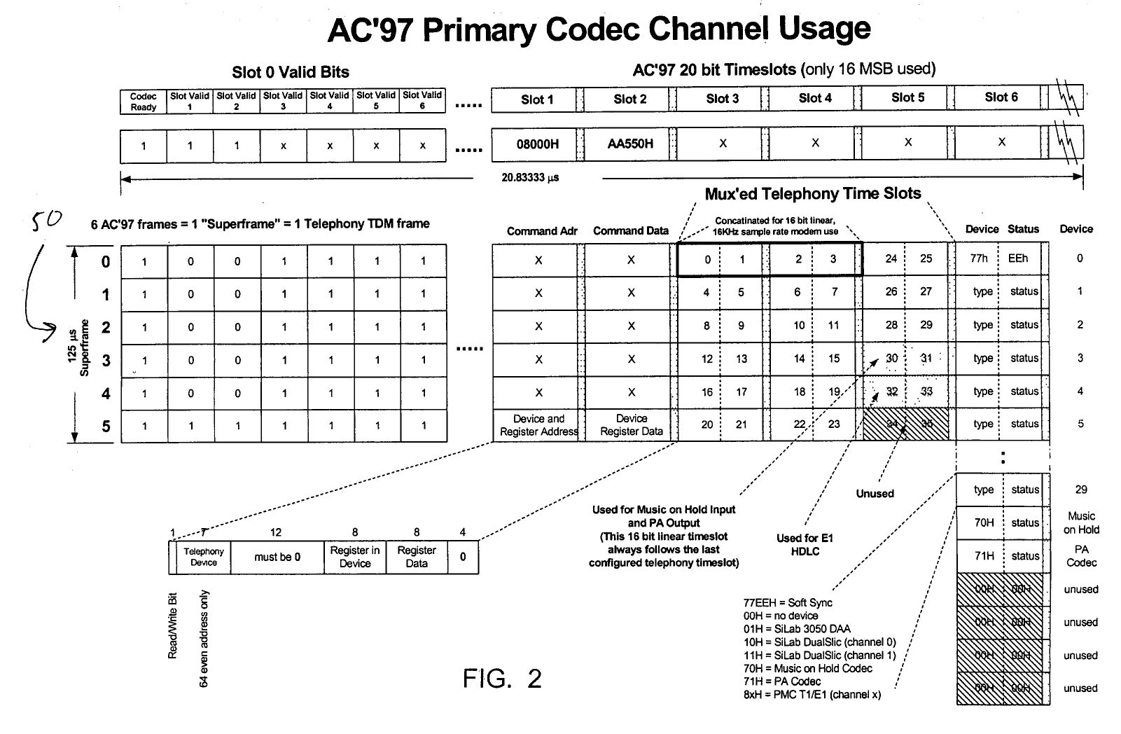

FIG. 2 illustrates the telephony channel usage of the AC '97 bus protocol performed by MUX module 14 of FIG. 1. An AC '97 TDM frame contains twelve 20-bit timeslots and 16 bits of header, or 256 bits in 20.8333333 μs. A telephony TDM frame contains 32 8-bit timeslots, which is also 256 bits, but in 125 μs. Therefore, six AC '97 frames fill the same time as 1 telephony frame. In one embodiment, six AC '97 frames is referred to as a “Superframe”.

In FIG. 2, an AC '97 frame is represented horizontally across the top. Only AC '97 timeslots 1-6 are shown since in one embodiment the DMA in the AC '97 controller provides support for only these timeslots. A Superframe 50 is shown at the center of FIG. 2.

AC '97 timeslots 3 and 4 are normally used for stereo Line-In and Line-Out. In one embodiment, one DMA for inbound and a second DMA for outbound are dedicated to timeslots 3 and 4. These timeslots are concatenated into one transfer with timeslot 3 assigned to stereo left and timeslot 4 assigned to stereo right. In one embodiment, only 16 of the 20 bits in each timeslot are utilized. These are the most significant bits. The implementation in one embodiment maps 24 unique telephony 8-bit timeslots into these dual AC '97 slots.

AC '97 timeslot 5 is normally used for soft-modem support. In one embodiment, two DMAs are dedicated for soft-modem use. A soft-modem does not require the same bandwidth as does the audio in timeslots 3 and 4. Therefore sample rate conversion is used that does not issue data in all of the AC '97 frames that comprise a Superframe. In this embodiment the full bandwidth of timeslot 5 is used. In this space of a Superframe, six telephony 8-bit timeslots are mapped in. Additionally one of the Superframe timeslots is used for 16-bit linear Music-on-Hold and PA. Another Superframe timeslot is used for 16-bit transfer of HDLC data when an E1 chip is implement, and one Superframe timeslot is unused.

AC '97 timeslot 6 is normally used for Microphone-In. In one embodiment, one DMA is dedicated to this timeslot. Here the concept of a Superframe is extended to include 36 AC '97 frames. 36 is used to maintain a modulo relationship with the data Superframe of 6 AC'97 frames. Four of the 36 frames are unused. The remainder of the frames allow for the DMA input of telephony codec runtime status information (i.e., OnHook, Ringing, Loop Current Detect, etc.). DMA is used instead of register polling by a processor such as a Pentium in order to minimize the number of AC '97 register reads. Such reads carry a performance burden on the system and should be avoided. The timeslot for each possible codec contains an 8-bit type value and 8-bits of runtime status information. The enumeration of the status bits is telephony codec dependant.

AC '97 timeslots 1 and 2 are used to address the AC '97 codec. There are 64 possible AC '97 registers. In the audio case this provides for functions like volume control, audio mixing, mute, etc. These are functions of MUX module 14. In this embodiment a limited number of registers in MUX module 14 are supported. The bulk of the available 64 registers are used for accessing each of the 31 possible telephony (and Music-on-Hold/PA) codec internal registers. These are functions of telephony codec module 16.

### Control and Status Register Usage

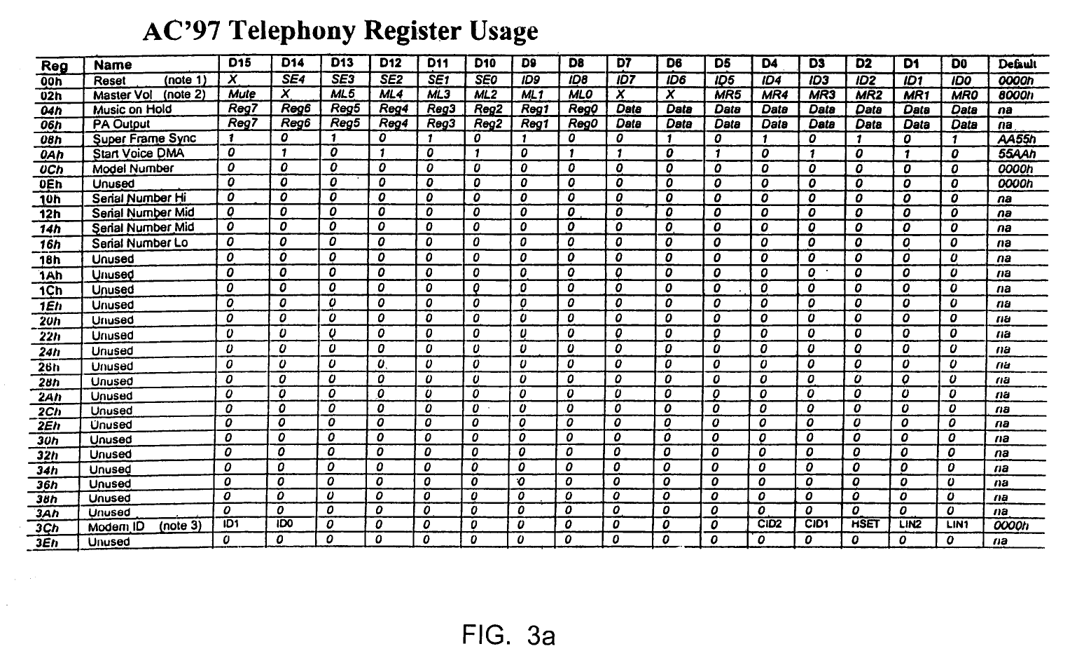

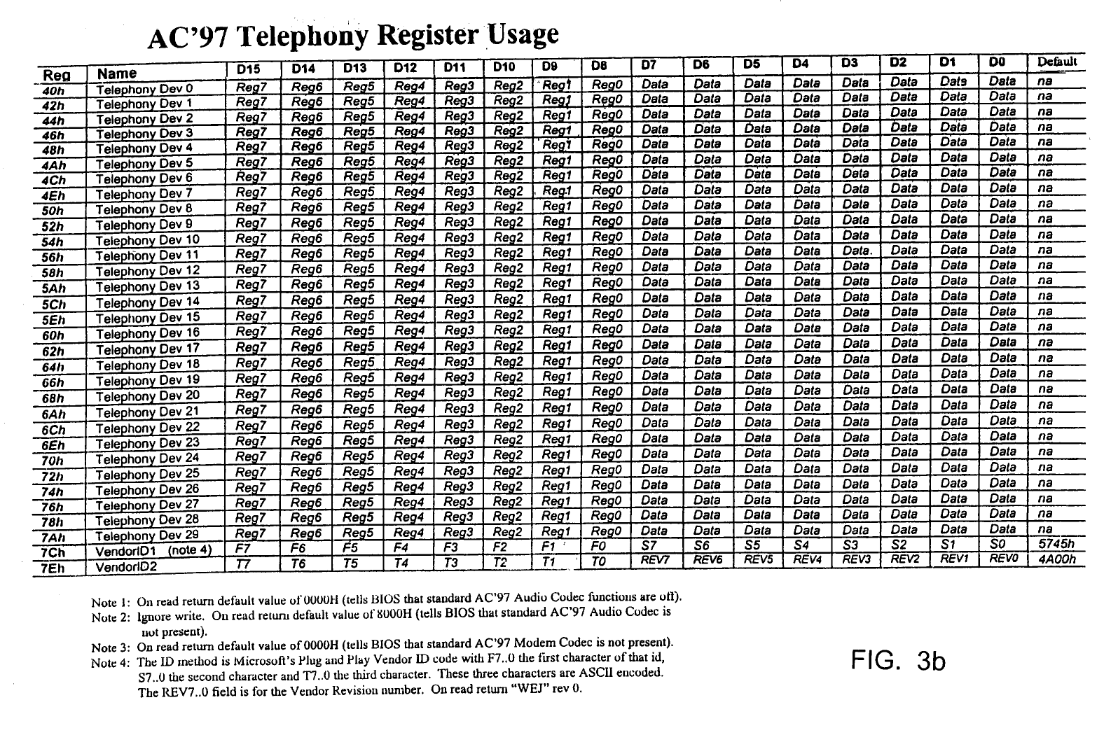

FIGS. 3a and 3b illustrates a map of the AC '97 telephony registers in accordance with one embodiment of the present invention.

A. Reset Register (Index 00h)

Writing any value to this register performs a register reset, which causes all registers to revert to their default values. Reading this register for a “standard” audio codec returns the ID code of the part and a code for the type of 3D Stereo Enhancement, if any. For this telephony codec a read returns 0000H. This prevents legacy BIOS code from detecting the telephony codec as an audio codec.

B. Play Master Volume Register (Index 02h)

A “standard” audio codec uses this register as the master volume control. There is no such function for the telephony codec. However legacy BIOS code does a write then read of this register to determine if the primary AC '97 codec is an audio codec. Therefore a write to this register is a no-op. A read returns 8000H which will fail the BIOS discover test for an audio codec.

C. Music on Hold Register (Index 04h)

This is a pass-thru register for accessing the music-on-hold codec. This codec is a telephony codec with the telephony circuitry replaced with a mono audio input. The details of the internal telephony codec used are design dependent.

D. PA Register (Index 06h)

This is a pass-thru register for accessing the Public Address codec. This codec is a telephony codec with the telephony circuitry replaced with a mono audio output. The details of the internal telephony codec used are design dependent.

E. Superframe Sync Register (Index 08h)

This is a write only register. It is used to synchronize all of the telephony codec clocks and signals to the beginning of a Superframe. This command is only needed once per run-time session.

Once a Superframe is synchronized the telephony codec status in AC '97 timeslot 6 is active. The voice data in AC '97 timeslots 3, 4 and 5 are not yet active. This period of no active data allows the host drivers to determine how many and what kind of telephony codecs are present by parsing the DMA buffer attached to AC '97 timeslot 6.

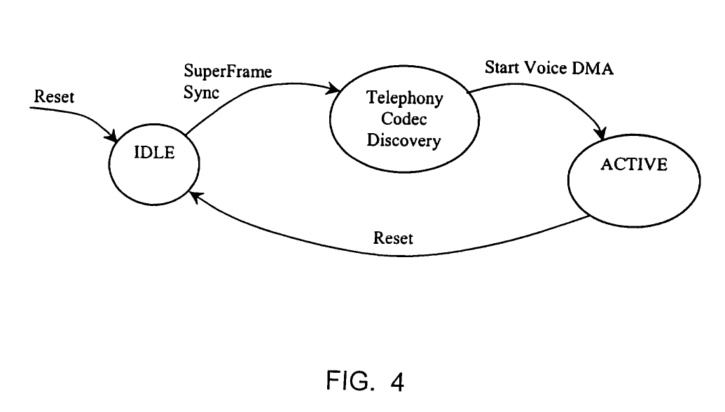

Before issuing this command, the DMA for AC '97 timeslot 6 must be initialized and made active. The DMAs for voice data need not be set up yet. FIG. 4 illustrates the bring-up state machine in accordance with one embodiment of the present invention.

F. Start Voice DMA Register (Index 0Ah)

This is a write only register. It is used to begin exchange of voice data. Once the host driver has established how many and what kind of telephony codecs exist, then this command is used to begin the data transfer.

Before issuing this command the DMAs for voice data must be initialized and made active. The size of the DMA buffers to use is directly related to the number of telephony codecs in the configuration.

G. Model Number Register (Index 0Ch)

This is a read only register. It returns a 16 bit model number which reflects a given telephony codec design configuration. This is model not revision of the model.

H. Serial Number Registers (Index 10h, 12h, 14h, 16h)

This is a read only register. It returns a 64 bit serial number with the high order bits in register 10h. Each manufactured telephony assembly has a unique serial number.

I. Modem ID Register (Index 3Ch)

A “standard” AC '97 modem code uses this register for control. There is no such function for the telephony codec. However legacy BIOS code does a write then read of this register to determine if the AC×97 codec is a modem codec. Therefore a write to this register is a no-op. A read returns 8000H that will fail the BIOS discover test for a modem codec.

J. Telephony Device X Register (Indexes 40h thru 7Ah)

There is one register for each possible telephony codec. These AC '97 registers are used to indirect address the internal registers of each telephony codec. The high order 8 bits contain the address of the internal telephony codec. The low order 8 bits contain the data to write or read from the internal telephony codec.

This mechanism is used to write and read the internal telephony codec registers. The exact content of these internal registers is codec specific. The host driver must identify the type of codec (via AC '97 timeslot 6 status buffer) before using this mechanism.

K. Vendor ID1, ID2 (Index 7Ch, 7Eh)

These two registers are read only. They are used to return the vendor ID of the AC '97 codec. The ID method is Microsoft Corp.'s Plug and Play Vendor ID code with F7..0 the first character of that ID, S7..0 the second character and T7..0 the third character. These three characters are ASCII encoded. The REV7..0 field is for the Vendor Revision number. On read “WEJ” rev x is returned.

### Soft Modem Support

In one embodiment, when one of the telephony codecs is a Si3050 from Silicon Labs Corp., a soft modem can be supported. The Si3050 can be set to deliver 16-bit linear, 16 KHz sampled data in 4 consecutive 8 KHz telephony timeslots. With this configuration any 4 consecutive telephony timeslots can be set up for modem support. This is shown in the FIG. 2 with telephony timeslots 0, 1, 2, and 3.

### T1/E1 Support

In one embodiment, either a single span of T1 or E1 can be supported.

A. T1

A single T1 span supports 24 telephony channels. These must be the first 24 telephony timeslots in FIG. 2. This occupies all of AC '97 timeslots 3 and 4.

Runtime control and status of each of the 24 telephony channels is accessed via registers internal to the T1 ship chosen. Typically there will be one internal register for each of the 24 channels. These registers are polled by the micro-controller 20 and delivered to the host via DMA of AC '97 timeslot 6. B. El

A single El span supports 30 telephony channels. These take up all 30 of the possible telephony timeslots in FIG. 2. This uses AC '97 timeslots 3, 4, and 5.

For E1, runtime control and status of each of the 30 telephony channels is transferred via a HDLC channel (E1 timeslot 16). Processing this control/status protocol is the responsibility of a host processor. This protocol receives and sends the control/status data in HDLC frames. These frames will be transported in telephony timeslots 32 and 33 in FIG. 2. The telephony codec will process the bit level HDLC framing, bit-stuffing, and error checking.

8 bits of each HDLC control/status frame will be transported once per AC '97 SuperFrame. Along with these 8 data bits will be a tag byte indicating where in the HDLC frame the byte belongs. These 16 bits are sent/received in one AC '97 frame out of the six frames in a SuperFrame. Following is the definition of these bits:

| | |
|---|---|
| Timeslot 32 | Timeslot 33 |
| Hi Order Byte | Low Order Byte |
| Frame Tag | Data |

| | |
|---|---|
| 00H | Idle |
| 01H | BOM - Begin of Message Frame |
| 02H | MOM - Middle of Message Frame |
| 03H | EOM - End of Message Frame |
| 04H | ABT - Message Frame Abort |
| 05H | CRC - Bad CRC |
| 06H | Frame Error |

On receive the Frame Tag byte indicates when a frame begins and how it ends. On transmit the Frame Tag byte is used to instruct micro-controller 20 when to start a frame and how to end it.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method of interfacing telephone data with a computer system, wherein the computer system comprises a computer time division multiplexed (“TDM”) bus, said method comprising:
receiving the telephone data from a plurality of telephony codecs over a telephony bus, the telephony data having a plurality of telephony time slots;
multiplexing the plurality of telephony slots into at least one computer bus time slot; and
transmitting the at least one computer bus time slot over the computer time division multiplexed bus.

2. The method of claim 1, wherein the telephony bus is a TDM bus.

3. The method of claim 1, wherein the computer TDM bus is an AC '97 bus.

4. The method of claim 1, further comprising multiplexing telephony control/status into the at least one computer bus time slot.

5. The method of claim 3, wherein the multiplexing comprises mapping 24 telephony time slots into an AC '97 SuperFrame.

6. A telephony interface system comprising:
a plurality of telephony codecs;
a telephony bus coupled to said codecs;
a multiplexing module coupled to said telephony bus;
a computer bus coupled to said multiplexing module; and
a computer bus controller coupled to said computer bus.

7. The telephony interface system of claim 6, wherein said telephony bus is a TDM bus.

8. The telephony interface system of claim 6, wherein said computer bus is a TDM bus.

9. The telephony interface system of claim 8, wherein said computer bus is an AC '97 bus.

10. The telephony interface system of claim 6, wherein said multiplexing module multiplexes a plurality of telephony slots from said telephony bus into at least one computer bus time slot.

11. The telephony interface system of claim 6, wherein said computer bus controller comprises a direct memory access engine.

12. A method of connecting a computer system to a telephone network comprising:
receiving a plurality of time slots of telephony data;
multiplexing two of the plurality of telephony data time slots into a computer data time slot; and
transmitting the computer data time slot in a computer data TDM frame on a computer bus.

13. The method of claim 12, wherein the time slots of telephony data are generated by at least one telephony codec.

14. The method of claim 12, wherein the computer bus is an AC '97 bus.

15. The method of claim 12, further comprising multiplexing telephony control/status into a second computer data time slot.
